(19) United States
(12) Patent Application Publication
(10) Pub. No.: US 2026/0210782 A1
(43) Pub. Date: Jul. 23, 2026

(54) OSCILLATOR BASED SENSORS

(71) Applicant: Cirrus Logic International Semiconductor Ltd., Edinburgh (GB)

(72) Inventors: John P. LESSO, Edinburgh (GB); James T. DEAS, Edinburgh (GB)

(73) Assignee: Cirrus Logic International Semiconductor Ltd., Edinburgh (GB)

(21) Appl. No.: 19/027,617

(22) Filed: Jan. 17, 2025

(51) Int. Cl. G01L 1/22

(52) U.S. Cl. CPC G01L 1/2293; G01L 1/2256

(57) ABSTRACT

This application relates to methods and apparatus for sensing using controlled oscillators. A sensor apparatus has a first ring oscillator formed a plurality of delay elements which generates a first oscillator signal. At least one of the delay elements is a sensing delay element which includes a sensor component with an electrical property that varies with a measurand of interest to vary a propagation delay of the sensing delay element, and hence an oscillation frequency of the first oscillator signal.

### FIELD OF DISCLOSURE

The field of representative embodiments of this disclosure relates to methods, apparatus and/or implementations concerning or relating to sensing, e.g. electrical, physical or chemical sensing, and, in particular, to sensing using oscillators.

### BACKGROUND

Sensing is required in a variety of different applications. In general, an electrical sensing circuit may comprise circuitry that generates an analog current or voltage related to a measurand of interest and an analog-to-digital converter (ADC) for converting the analog current or voltage in a digital output.

One example, where sensing is typically required, is for driving output transducers, e.g. driving loudspeakers in audio applications. In such applications it may be desirable to monitor one or more of temperature, current and voltage of the driver circuit for implementing appropriate control and/or protection of the driver circuit.

Driver circuits for driving output transducers have been implemented as an integrated circuit formed in a silicon substrate. For some applications, however, the use of compound semiconductor materials is increasingly being proposed for at least the output power stage of a circuit, such as a DC/DC converter or the output stage of a switching driver or class-D type amplifier may be implemented as an integrated circuit formed in Gallium Nitride (GaN) substrate. The properties of GaN can make it advantageous for use in some applications, for instance for high power and/or high voltage applications. However, the properties of GaN can pose challenges for integrating other circuitry, such as sensing circuitry, into the GaN device. For instance, as will be understood by one skilled in the art, whilst n-channel devices can be readily formed in a GaN substrate, the commercially available fabrication techniques are generally not able to form effective p-channel devices and thus complementary integrated circuits designs are generally not available for use in GaN circuits.

### SUMMARY

Embodiments of the present disclosure relate to methods and apparatus for sensing that at least mitigate at least some of the above-mentioned issues. In particular, at least some embodiments may be suitable for use in integrated circuits formed in compound semiconductors materials such as GaN, but it will be understood that embodiments may also be implemented in integrated circuits formed in silicon.

According to an aspect of the disclosure there is provided a sensor apparatus comprising: a first ring oscillator comprising a plurality of delay elements configured to generate a first oscillator signal. At least one of the delay elements comprises a sensing delay element which comprises a sensor component with an electrical property that varies with a measurand of interest to vary a propagation delay of the sensing delay element and hence an oscillation frequency of the first oscillator signal.

In some implementations, the sensing delay element may comprise the sensor component connected in series with a switching device. A control terminal of the switching device may be configured to be driven by an input to the sensing delay element. An output of the sensing delay element may be taken from a node between the series connected sensor component and switching device. The switching device may comprise an n-channel transistor or an enhancement high electron mobility transistor.

In some implementations, each of the plurality of delay elements of the first ring oscillator comprises a sensing delay element.

In some implementations, the sensor component may comprise a resistance having a resistance value which varies with the measurand of interest.

In some examples the measurand of interest may be temperature and the resistance has a first temperature coefficient of resistance. In some examples the measurand of interest may be strain and the variable resistance may comprise a resistive strain sensor. In some examples the resistance may comprises a two-dimensional electron gas resistive element. In some example, the sensor apparatus may be configured for sensing for one or more target chemical analytes of interest, and the sensor apparatus may comprise a functional layer overlying the two-dimensional electron gas resistive element, where the functional layer is configured to interact with the one or more target chemical analytes of interest to vary a charge or electric field distribution over the two-dimensional electron gas and hence the resistance of the two-dimensional electron gas resistive element.

In some implementations, the sensor component may comprise a variable current component that provides a current which varies with the measurand of interest.

In some examples the measurand of interest may be a magnetic field strength and the variable current component may comprise a Hall sensor configured to provide current steering between first and second output electrodes. In some implementations, the sensor apparatus may further comprise a second ring oscillator with at least one sensing delay element and the Hall sensor may be configured as a shared sensing component for a sensing delay element of each of the first and second ring oscillators. The Hall sensor may be connected as part of the sensing delay element of the first ring oscillator via the first output electrode and be connected as part of the sensing delay element of the second ring oscillator via the second output electrode. In some implementations, the sensor apparatus may comprise a plurality of Hall sensors configured in a stacked arrangement such that an output current from one of the first and second output electrodes of a first one of the Hall sensors provides an input current for a second one of the Hall sensors.

The sensor apparatus may further comprise a second ring oscillator comprising a plurality of delay elements configured to generate a second oscillator signal. The first and second rings oscillators may be configured such that any variation in frequency of the second oscillator signal with the measurand of interest is different to the variation in frequency of the first oscillator signal. In some implementations, the second ring oscillator may be configured such that the frequency of the second oscillator signal does not vary with the measurand of interest. The sensor apparatus may further comprise a counter configured to count a number of oscillations of one of the first and second oscillator signals in a count period, and a frequency divider configured to apply frequency division to the other of the first and second oscillator signals to define the count period.

The sensor apparatus may be implemented as a gallium nitride based integrated circuit.

In another aspect, there is provided a sensor apparatus comprising: a first ring oscillator comprising a plurality of delay elements configured to generate a first oscillator signal; wherein at least one delay element comprises a sensor component connected between a first voltage and a delay element output node and a switching device connected between the delay element output node and a second voltage; and wherein the sensor component provides at least one of a variable resistance and a variable current that varies with a measurand of interest.

In another aspect, there is provided a sensor apparatus comprising: a first ring oscillator comprising a plurality of delay elements configured to generate a first oscillator signal, wherein at least one of the delay elements is configured to provide a propagation delay which varies with a measurand of interest so as to vary a frequency of the first oscillator signal; and decode circuitry configured to receive and decode the first oscillator signal so as to provide a measurement signal indicative of the measurand of interest.

The sensor apparatus may comprise a second ring oscillator comprising a plurality of delay elements configured to generate a second oscillator signal and wherein the second oscillator signal is used to define a count period for counting a number of oscillations of the first oscillator signal.

It should be noted that, unless expressly indicated to the contrary herein or otherwise clearly incompatible, then any feature described herein may be implemented in combination with any one or more other described features.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates a conventional controlled ring oscillator;

FIGS. 2a and 2b illustrate examples of oscillators with sensing functionality according to an embodiment;

FIG. 3 illustrates one example of a sensor arrangement using two ring oscillators;

FIG. 4 illustrates an example of a sensing component for chemical sensing;

FIG. 5 illustrates an example of a sensing delay element with a Hall effect sensor for magnetic sensing;

FIG. 6 illustrates sharing of Hall effect sensors between two ring oscillators; and

FIG. 7 illustrates stacking of Hall sensors to provide increased sensitivity.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

Embodiments of the disclosure relate to oscillator-based sensors, that is to sensors implemented with an oscillator that has an oscillation period, and hence frequency, that varies with a measurand of interest.

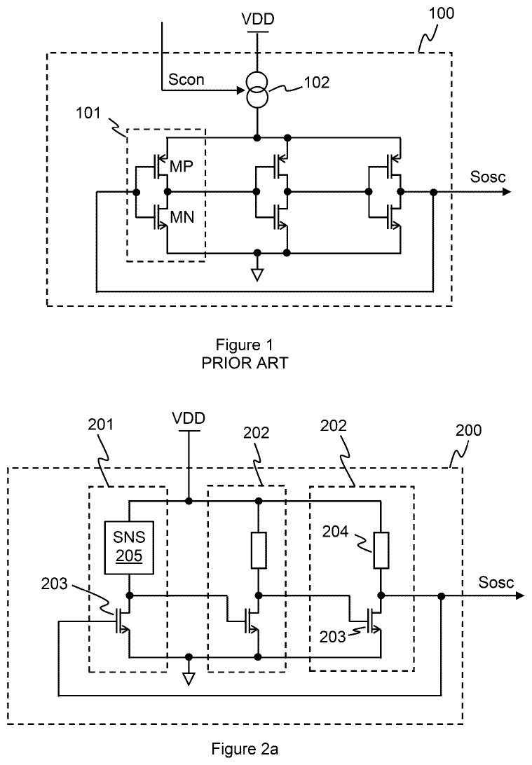

Controlled oscillators, such as voltage-controlled oscillators (VCOs), are known and may be constructed by a ring arrangement of delay elements such as inverters. FIG. 1 illustrates one example of a basic form of ring oscillator 100 as may be implemented by CMOS device on a silicon substrate. The ring oscillator 100 in this example comprises an odd plurality of inverters 101, each of which comprises a PMOS transistor MP in series with an NMOS transistor MN between high-side and low-side voltages, e.g. a supply voltage VDD and ground. The output of each inverter 101, which is taken from the midpoint of the series connected transistors MP and MN, provides the gate drive input for the next inverter. The PMOS and NMOS transistors act in a complementary manner to drive the output of the inverter 101 high or low depending on the input to the inverter 101. An output is tapped from an appropriate part of the ring arrangement to provide the output signal Sosc from the ring oscillator 100.

The output frequency of the ring oscillator 100, i.e. the frequency of the output signal Sosc, depends on the number of inverters 101 in the ring arrangement and the individual propagation delay associated with each inverter. The propagation delay of each inverter 101, i.e. the delay between a change in the input and a corresponding change in the output of the inverter 101, depends on the properties of the transistors and the drive strength of the inverters, i.e. how quickly the output of one inverter can charge or discharge the gate capacitances of the PMOS and NMOS device of the next inverter to drive the output voltage high or low as appropriate.

To provide a controllably variable output frequency, the drive strength of the inverters 101 may be controllably varied in use so as to vary the propagation delay of the inverters. FIG. 1 illustrates an example where a received control signal Scon, for instance a control voltage for a VCO implementation, is used to control a current source arrangement 102 that defines the strength of the drive signal which is output from each inverter, but it will be understood that other arrangements are possible. In general, though, the received control signal Scon varies the propagation delay of the inverters 101, and consequently the output frequency of the VCO 100.

Ring oscillators such as described with reference to FIG. 1 may be used for a range of different applications, such as generation of clock signals. VCOs have also been used as part of an analogue-to-digital converter (ADC) arrangement, and some VCO based ADCs can have the advantage of being small in circuit area, although non-linearity can be a significant issue.

Embodiments of the present disclosure provide a sensing functionality within an oscillator, such that the oscillation period and hence output frequency of the oscillator varies with the measurand of interest.

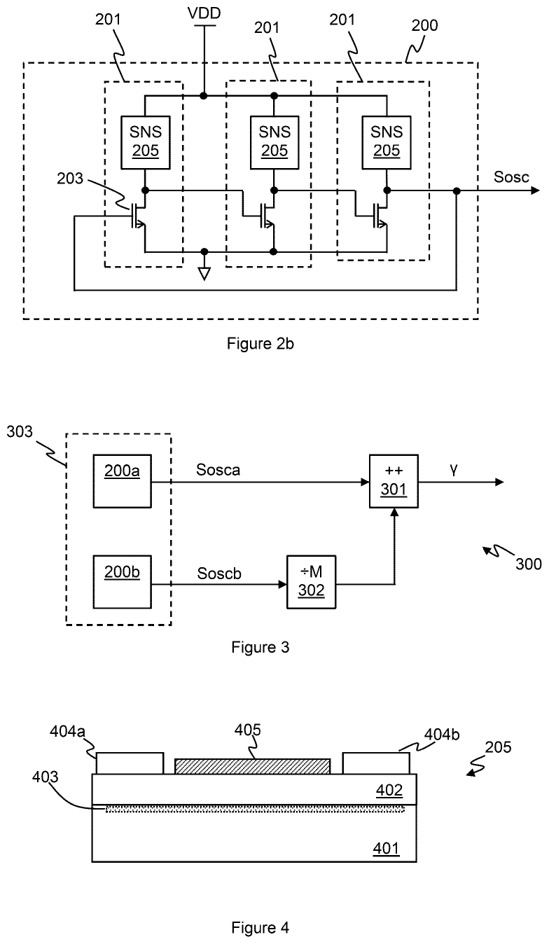

FIGS. 2a and 2b illustrates two examples of oscillators 200 with sensing functionality according to an embodiment. In each case, the oscillator 200 comprises an odd number of inverting delay elements arranged in a ring arrangement in a similar manner as the oscillator of FIG. 1. However, in the examples of FIGS. 2a and 2b at least one of the delay elements includes sensing functionality.

FIG. 2a illustrates an embodiment where one sensing delay element 201, implemented with sensing functionality, is arranged as part of the ring oscillator with a plurality of non-sensing delay elements 202.

The non-sensing delay elements 202, in this example, are coupled between high-side and low-side voltages, e.g. a supply voltage VDD and ground respectively. Each of the non-sensing delay elements 202 comprises a pull-up arrangement and a pull-down arrangement for driving the output high or low depending on the state of the input. In the example of FIG. 2a, the pull-down arrangement comprises a transistor 203 implemented as a switching device connected between the output for the non-sensing delay element 201 and the low-side voltage, e.g. ground, with its control terminal, e.g. gate, driven by the input for the non-sensing delay element 201. The transistor 203 may be an n-channel transistor or a transistor such as an enhancement mode high electron mobility transistor (HEMT). In the example of FIG. 2a, the pull-up arrangement of the non-sensing delay element 201 comprises a resistance 204. In use, when the transistor 203 is on, i.e. conducting, the output of the non-sensing delay element 201 is pulled down to the low side voltage, whereas when the transistor 203 is off, i.e. non-conducting, the output of the non-sensing delay element 201 is pulled high. The pull-up provided by the resistance 204 is thus an inherent or passive pull-up that occurs when the transistor 203 is non conducting.

The use of a resistance 204 as the pull-up element for the non-sensing delay elements 201 means that the non-sensing delay elements 201 can be implemented without the need for any p-channel transistors, which means that such delay elements can be readily implemented in compound semiconductor materials such as Gallium Nitride (GaN). However, embodiments may be implemented in any suitable material system, and in applications implemented on a silicon substrate, the non-sensing delay elements 201 could be implemented with a resistance 204 (as illustrated in FIG. 2a) or could be implemented using conventional inverters 101 such as described with reference to FIG. 1. Note, in the example of FIG. 2a, the resistance 204 of a non-sensing delay element 202 could be implemented by a passive resistor of a suitable material, or a combination of such resistors, or could be implemented by one or more active devices, e.g. by a depletion mode n-channel transistor having a connected gate and source.

The propagation delay of each non-sensing delay element 202 depends on the drive strength of the non-sensing delay element 202. The drive strength of the output from each non-sensing delay element 202 depends on the supply voltages, e.g. on VDD, and the properties of the n-channel transistor 203 and resistance 204.

The propagation delay for the non-sensing delay element 202 can be represented in terms of the rise time for of the output of the non-sensing delay element 202 to go high when its input is low or the fall time for the output of the non-sensing delay element 202 to go low when its input is high as appropriate.

The fall time, tf, can be represented as:

$$tf = \frac{( VDD - Vt ) {C}_{L}}{It} \qquad Eqn . ( 1 )$$

where VDD is the value of supply voltage, Vt is the threshold voltage for the transistor 203, C_{L} is the capacitance of the load at the output of the delay element, e.g. the gate capacitance of the transistor 203 of the next delay element in the ring, and It is the drain-source current of the transistor 203 when on (assuming saturation) which is given by:

$$It = {k ( VDD - Vt )}^{2} \qquad Eqn . ( 2 )$$

The rise time can be modelled by considering the time taken for the output voltage Vo to go from 10% of VDD to 90% of VDD. The output voltage Vo is given by:

$${V}_{o} = VDD ( 1 - {e}^{- t / R . {C}_{L}} ) \qquad Eqn . ( 3 )$$

where R is value of the resistance 204. The rise time from Vo=0.1VDD to Vo=0.9VDD can thus be determined as:

$$tr = {RC}_{L} ln ( 9 ) \qquad Eqn . ( 4 )$$

It can thus be seen that the rise time of the non-sensing delay element 202 has a dependence on the value of the resistance 204.

The sensing delay element 201 may comprise essentially the same pull-down arrangement as a non-sensing delay element 202, i.e. a transistor 203 (which may be an enhancement HEMT or n-channel transistor) connected between the output of the sensing delay element 201 and the low-side voltage, e.g. ground, with its gate controlled by the input to the sensing delay element 201. However, the pull-up arrangement for the sensing delay element 201 comprises a sensor component 205 which provides a propagation delay for the sensing delay element 201 which varies with a measurand of interest. The sensor component 205 is configured to have an electrical property that varies with the measurand of interest to provide the variable propagation delay, e.g. a variable rise time. For instance, in some implementations the sensor component 205 may comprises a variable resistance, with a resistance that varies with the measurand of interest.

For such a sensing delay element 201, assuming the transistor 203 has the same characteristics as that of a non-sensing delay element 202, the fall time tf for the output of the sensing delay element 201 will also be given by equations 1 and 2 above. The rise time for the sensing delay element 201 may also be determined by equation 4 above, but the value of the resistance of the sensor component 205 may vary with the measurand of interest, e.g. as R+ΔR where ΔR is the variation with the measurand of interest. The rise time for the sensing delay element 201 will thus vary with the measurand of interest, with a consequent variation in the overall cycle period of the controlled oscillator 201 and hence the output frequency. A change ΔR in the resistance of the sensor component 205 will result in a change Δtr in the rise time for that sensing delay element which is equal to ΔRC_{L}In(9) and hence a consequential change in the cycle period for the oscillator 200. It will be noted that the change in oscillation period may thus be generally linear with a change in resistance for the sensing delay element 201. This relationship between a change in resistance of the sensor component 205 and a change in output period for embodiments of the present disclosure can provide a greater linearity than between a change in voltage in a conventional VCO such as discussed with reference to FIG. 1.

Whilst FIG. 2a illustrates that just one of the delay elements of the oscillator 200 is implemented as a sensing delay element 201, in some embodiments more than one of the delay elements of the oscillator 200 may be implemented as a sensing delay element. FIG. 2b illustrates an embodiment where each of the delay elements of the oscillator 200 is implemented as a sensing delay element 201. In this case the rise time of each of the sensing delay elements 201 may vary with the value of the resistance of the relevant sensor component 205. Assuming all the sensing delay elements 201 respond in substantially the same way to the relevant measurand, this can provide a greater change in oscillator period t_{osc} for a given change in measurand and thus increase sensitivity. In this case, the change in oscillation period is effectively an indication of the average change in measurand indicated by all of the sensing delay elements 201.

As a complete cycle of oscillation of the oscillator 200 involves the output of each delay element undergoing both a high-to-low transition and a low-to-high transition, the overall oscillation period is thus a sum of the rise and fall times of each of the delay elements and thus a variation in the rise time of the sensing delay element 201 results in a variation in the period of oscillation.

The overall period of oscillation t_{osc} can be given by:

$$\begin{matrix}{t}_{osc} = \frac{{C}_{L} N}{k ( VDD - Vt )} + R \{ {C}_{L} N ln ( 9 ) \} \\ = 1 + kR ( VDD - Vt ) ln ( 9 )\end{matrix} \qquad Eqn . ( 5 )$$

where N is the number of delay elements in the ring and R, in this case, is the average resistance of the pull-up arrangements of the delay elements, i.e. the average resistance of the sensor component 205 of the sensing delay element(s) 201 and the resistances 204 of any non-sensing delay element.

Embodiments of the present disclosure may be implemented to provide sensing for a range of different possible measurands, provided that the sensor component 205 can provide a propagation delay for the sensing delay element 201 that varies with the measurand of interest. As mentioned above, this may, in some examples, be achieved by implementing the sensor component 205 to provide a variable resistance.

In one example, the oscillator 200 with sensing functionality may be implemented as a temperature sensor, in which case each sensing delay element 201 may be implemented with a resistance for the sensor component 205 where the resistance has a temperature coefficient of resistance such that the resistor exhibits a relatively significant variation in resistance with temperature.

The sensor component 205 of the sensing delay element 201 could be implemented by any suitable arrangement that provides a resistance that varies with temperature. For example, one or more resistors of a suitable resistive material could be used to provide the variable resistance. In some examples, the resistance could be provided by an active load, e.g. a n-channel depletion transistor connected to provide a resistance, e.g. with its gate and source terminals connected. In some material systems, the variable resistance may be implemented by a two-dimensional electron gas (2DEG). As will be understood by one skilled in the art, 2DEGs can be formed by suitable heterojunctions, e.g. in GaN a 2DEG can be formed at a GaN/AlGaN heterojunction. The 2DEG has a charge carrier mobility, and hence conductance/resistance, that can vary with temperature. A 2DEG can thus be utilised as a resistance which varies with temperature and at least some 2DEGs can exhibit an effective temperature coefficient of resistance which is relatively high.

An oscillator 200 such as illustrated in FIG. 2a or FIG. 2b could thus be implemented with temperature variable resistances for the sensor components 205 to provide an oscillation frequency that varies with temperature.

The output signal from such an oscillator 200 would thus be indicative of temperature changes affecting the sensing delay elements 201 of the oscillator 200. In at least some applications, this oscillator output signal may be demodulated or decoded to provide a measurement signal.

It would be possible to demodulate the output signal from the oscillator 200 by determining the frequency of the oscillation signal, e.g. by counting the number of oscillations of the output signal in a count period defined by a stable reference clock and converting the frequency into an indication of temperature, however it will be noted from equation 5 that the oscillation period is proportional to resistance and thus the oscillation frequency is inversely proportional to the frequency of the oscillation signal. A decode in time, rather than frequency may, therefore, be advantageous. The oscillation period could be determined by counting the number of pulses of a fast reference clock in a count period defined by the oscillation signal, but this may require a fast reference clock. Also, both these approaches would require a stable reference clock and ideally require a well-regulated power supply for the controlled oscillator 200, as the oscillation period also has a dependence on the supply voltage.

In some embodiments therefore, a sensor system may be implemented with two oscillators, where one oscillator is used to provide demodulation of the other controlled oscillator.

FIG. 3 illustrates one example of such a sensor system 300 comprising first and second oscillators, labelled as 200a and 200b. In the example of FIG. 3 each of the first and second oscillators 200a and 200b comprises an oscillator 200 with sensing functionality such as described with reference to FIG. 2a or 2b but the oscillators 200a and 200b are implemented such that the temperature coefficient of resistance of the sensor component 205 of the sensing delay element(s) 201 of the first controlled oscillator 200a is different to that of the second controlled oscillator 200b. For some applications, however, only one of the first and second oscillators 200a and 200b may be implemented with sensing functionality and the other oscillator may be implemented by an oscillator formed purely from a ring arrangement comprising non-sensing delay elements 202 such as discussed with reference to FIG. 2a.

The output signal Sosca of the first oscillator 200a is supplied to a counter 301 which counts the number of oscillations of the output signal Sosca in a defined count period to provide a count value y. The output signal Soscb of the second oscillator 200b is supplied to a frequency divider 302 which divides the frequency by a factor M and supplies the frequency divided signal to the counter 301 to define the count period. Note, for correct decoding the

The count value y can, from equation 5 above, be seen as:

$$γ = M \frac{1 + kRb ( VDD - Vt ) ln ( 9 )}{1 + kRa ( VDD - Vt ) ln ( 9 )} \qquad Eqn . ( 6 )$$

where Ra is the average resistance average resistance of the pull-up arrangements of the delay elements for the first oscillator 200a and Rb is the average resistance average resistance of the pull-up arrangements of the delay elements for the second oscillator 200b.

This can be approximated as:

$$γ \approx M \frac{Rb}{Ra} \qquad Eqn . ( 7 )$$

If Ra is expressed as Rₐ=Ra0 (1+aₐT) and Rb=Rb0 (1+a_{b}T), where T is temperature Ra0 and Rb0 are the respective resistance values at a temperature of zero and aₐ and a_{b} are the respective temperature coefficients of resistance for the first and second oscillators 200a and 200b respectively, then:

$$γ = M \frac{Rb 0 ( 1 + α bT )}{Rb 0 ( 1 + α aT )} \approx M \frac{Rb 0}{Ra 0} \{ 1 - ( {α}_{a} - {α}_{b} ) T \} \qquad Eqn . ( 8 )$$

It can be seen that the count value y will thus vary in a generally linearly manner with temperature. Note that for a correct decode, it should be ensured that the count period is greater than twice the oscillation period of the output signal Sosca of the first oscillator 200a, i.e. the frequency of the output signal Sosca of the first oscillator 200a should be greater than M/2 times the frequency of the output signal Soscb of the second oscillator 200b.

In this example, for temperature sensing, the sensitivity, in terms of variation in count value with temperature, depends on the difference between the temperature coefficients of resistance da and a, for the two controlled oscillators, and thus it is generally beneficial to implement the first and second oscillators 200 with a relatively large difference in the temperature coefficient of resistance. For instance, one of the first and second oscillators 200a and 200b could be implemented with a 2DEG (with a relatively high temperature coefficient of resistance) as the variable resistance of the sensor component 205, whilst the other of the first and second oscillators 200a and 200b could be implemented with resistors formed from a material such as silicon carbide, silicon chromium, or silicon carbide chrome (with a relatively low temperature coefficient of resistance).

The count value y could, in some applications, be used to provide a measurement signal S_{M} representing the measurand of interest, e.g. in this example an indication of absolute temperature or an indication of temperature change. For instance, some downstream processing (not illustrated) may be applied to translate the count value y to the desired measurement signal, for instance using a suitable look-up table (LUT) of calibrated and/or modelled count values against temperature or applying some defined transfer function.

The sensor component 300 thus provides a means of sensing a measurand of interest, such as temperature in the example discussed, using oscillators. It will be noted that using the output of the second oscillator 200b to define the count period for counting the number of oscillations of the first oscillator 200a means that any variation in the respect count period due to variations in supply voltage VDD substantially cancel. This arrangement also avoids the need for any accurate reference clock.

The sensor component 300 may advantageously be implemented in an integrated circuit with only a relatively small footprint, i.e. which only requires a relatively small circuit area. The oscillators 200a and 200b can themselves be implemented as small components and the counter 301 and frequency divider 303 can also be small in area. The sensor component 300 may advantageously be relatively low power. As the sensing functionality is provided by the sensor component 205 of the sensing delay element(s) 201 of the oscillators, the power for the sensor component 205 also powers the oscillator, i.e. there is no need to separately power both a sensor and an oscillator.

As noted above, the first and second oscillators 200a and 200b can be implemented without requiring any p-channel devices, meaning that they can be readily implemented in material systems such as GaN. In some applications, the frequency divider 302 and/or the counter 301 may formed as part of the same integrated circuit (IC) with the first and second oscillators 200a and 200b and in materials systems such as GaN, the frequency divider 302 and/or the counter 301 may thus be implemented without using any p-channel devices. One skilled in the art will understand there are various ways a frequency divider and a counter could be implemented with requiring the use of a p-channel device. In some implementations, however, the first and second oscillators 200a and 200b could be implemented as part of a first IC 303 with at least one of the frequency divider 302 and counter 301 being external, i.e. off chip, to that first IC 303, e.g. formed as part of a different IC. This may allow the first and second oscillators to be implemented as part of the first IC 303 where the sensing is required, which may be formed in a first material system, such as GaN, but the decode circuitry, i.e. the frequency divider 302 and counter 301 could be implemented as part of a second, different, IC which could be implemented in a different material system, such as silicon. This arrangement has the advantage that the output signals Sosca and Soscb, which will be output from the first IC, are essentially digital time-encoded signals. The transmission of such digital signals between different ICs may be more robust and/or less likely to introduce noise compared to the transmission of analogue signals, which may be the case with some other sensing arrangements where a sensor is arranged as part of the first IC and ADC is arranged to provide a decode on a different IC. Note this advantage of transmitting a digital time-encoded signal indicative of the measurand would also apply in the case where a single oscillator with sensing functionality were implemented and decoded using a stable reference clock.

The examples discussed above have focussed on temperature sensing, but as noted above embodiments may be implemented to provide sensing of a range of different properties.

For instance, strain sensing based on strain gauges that provide a change of resistance with applied strain are known. A strain sensor could be implemented using such a resistive strain gauge as the sensor component 205 of the sensing delay element(s) 201 of either of the examples of FIG. 2a or FIG. 2b.

Such as strain sensing oscillator could be used for one of the first or second oscillator 200a or 200b as part a sensor component 300 for strain sensing. In this case, the other one of the first or second oscillators 200a or 200b may be implemented with no strain sensing functionality, i.e. the oscillator may simply comprise a ring arrangement of non-sensing delay elements. In some implementations, however, each of the first and second oscillators 200a and 200b may be configured as strain sensing oscillators, with the first and second oscillators 200a and 200b being configured to provide different changes in resistance for a given applied strain. For instance, the resistive strain gauge(s) used for the variable resistance(s) of the sensing delay element(s) 201 of the first oscillator 200a may be arranged to provide a change in resistance to a given applied strain which is of the opposite polarity to that of the resistive strain gauge(s) used for the variable resistance(s) of the sensing delay element(s) 201 of the second oscillator 200b. In other words, the sensor component 205 of a sensing delay element 201 of the first oscillator 200a to a given applied strain may result in a resistance change of +ΔRa, whereas the same strain applied to the sensor component 205 of a sensing delay element 201 of the second oscillator 200b may lead to a resistance change of −ΔRb.

As described above the sensing arrangement 300 of FIG. 3 may advantageously result in variations due to power supply fluctuations substantially cancelling. In addition, if temperature is not the measurand of interest and the first and second oscillators are implemented with resistances with the same or similar temperature coefficients of resistance, variations due to temperature may also substantially cancel.

In some applications, the sensor component 205 may be arranged to provide chemical sensing. The sensor component 205 may, for example, comprise a functional material that reacts with one or more target chemicals in a way that results in a change of resistance of the sensor component. In some implementations, a 2DEG may be used as a chemical sensor due to its relatively high sensitivity to surface effects.

FIG. 4 illustrates one example of a suitable sensor component 205 based on a 2DEG that could be used to provide chemical sensing functionality. The sensor component 205 comprises a first and second semiconductor materials 401 and 402 arranged to form a heterojunction that can give rise to a 2DEG. For instance, the first semiconductor material 401 may be GaN and the second semiconductor material 402 may be AlGaN.

In such a heterojunction, a 2DEG 403 can form at the junction interface due to polarization effects, creating a highly conductive layer. Electrodes 404a and 404b are configured to allow a current to flow between the electrodes via the 2DEG 403.

In use, the charge or electric field distribution overlying the 2DEG can impact the carrier density and conductivity of the 2DEG and hence the resistance of 2DEG. This can be used to provide chemical sensing, e.g. for sensing of target chemical analytes. If the relevant analyte adsorbs onto, or otherwise interacts or reacts with, a sensing surface overlying the 2DEG in a manner that results in a change in charge or electric field distribution, this can result in the change in resistance of the 2DEG. In the example of FIG. 4, an optional functional layer or catalyst, e.g. platinum, 405, is disposed over at least part of the area of the 2DEG, where the functional layer 405 comprises a layer which is tailored to interact with the target chemical analytes of interest to provide a variation in charge or electric field. Various suitable functional layers are known and used in other electrochemical sensing methods and such functional layers could be used in embodiments of the present disclosure.

The sensor component 205 illustrated in FIG. 4 could thus be used for the sensing delay element(s) 201 of the oscillator 200 of the examples of FIG. 2a or 2b, such that in the presence of the target chemical analyte(s), the output oscillation frequency of the oscillator varies.

Depending on the application, the oscillation frequency could simply be monitored for a change above a threshold amount which indicates that a relevant analyte is present and interacting with the functional layer. In which case the output of a single such oscillator could be monitored for a change in count value above a threshold, although it may be beneficial to provide a second oscillator constructed using similar 2DEGs but without the functional layer to provide calibration for power supply and/or temperature variations. For instance, the sensor component of FIG. 3 could be implemented with one of the first and second oscillators 200a and 200b having the chemical sensing functionality and the other having the non-chemical sensing arrangement. In some implementations, the amount of change in resistance of the 2DEG may vary depending on the relative concentration of the target analyte(s) and thus the sensor component of FIG. 3 may be used to provide a count value y indicative of the concentration.

It will thus be clear that any sensor component which provides a resistance which varies with a measurand of interest could be used as the sensor component 205 of an oscillator 200 of an embodiment of the present disclosure. Such an oscillator with sensing functionality could then be used as part of a sensor apparatus such as illustrated in the FIG. 3, other it will be understood that other arrangements could be used.

The examples discussed above have focused on the sensor component 205 of a sensing delay element 201 providing a variable resistance, so as to provide a variable propagation delay for the sensing delay element 201. However, the propagation delay of a sensing delay element 201 could also be varied in other ways, for instance by varying the current that flows to/from the output of the sensing delay element 201 via the sensor component 205.

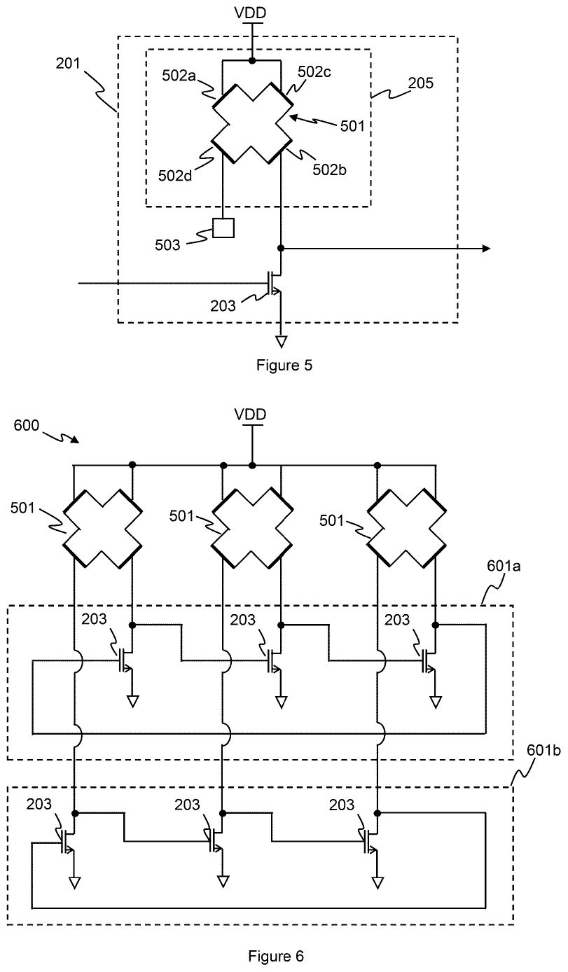

FIG. 5 illustrates one example of a sensor component 205 implemented as part of a sensing delay element 201 which provides a current which varies with the measurand of interest. In example of FIG. 5, the sensor component comprises a Hall sensor 501.

As will be understood by one skilled in the art, a Hall sensor is a known sensor for sensing a magnetic field based on the Hall effect. Typical Hall sensors comprise a planar material, with a first pair of electrodes 502a and 502b on opposite sides of the planar material to one another on a first axis and a second pair of electrodes 502c and 502d on opposite sides of the planar material to one another on a second axis, which may typically be substantially orthogonal to the first axis. For conventional Hall sensing, the Hall sensor is used in a voltage mode, in which a known voltage may be applied across one of the first and second pairs of electrodes to generate a DC bias current and potential difference between the other of the first and second pairs of electrodes is measured to provide a measurement signal of the applied magnetic field strength.

In the sensor component 205 illustrated in FIG. 5, however, the Hall sensor 501 is operated in a current mode in which the supply voltage VDD is applied to one of the electrodes of each of the first and second pairs, e.g. to electrodes 502a and 502c as illustrated such that, in use, current flows from these electrodes to the other electrodes 502b and 502d and the division of the current between the electrodes 502b and 502d varies with the applied magnetic field strength. The Hall sensor in this configuration thus provides current steering between the electrodes 502b and 502d, where the extent of the current steering varies with the strength of the of the applied magnetic field, that is the proportion of current steered to the electrode 502b rather than to electrode 502d varies with the applied field strength.

In the example of FIG. 5, the electrode 502b is connected to the output node of the sensing delay element 201, which is also connected to the n-channel transistor 203 of the sensing delay element. In this example the electrode 502d of the Hall sensor is connected to a suitable termination 503. In use, the current that flows to the output node of the sensing delay element 201 via the Hall sensor 501 thus had a dependence on the magnetic field strength acting on the Hall sensor, and hence the rise time of the sensing delay element varies with field strength so as to provide a variable propagation delay for the sensing delay element and hence the oscillator 200.

An oscillator where the sensor component(s) 205 of the sensing delay element(s) 201 is implemented by a Hall sensor in this way, can thus provide an output oscillation signal with an oscillation period/frequency which varies with magnetic field strength. An oscillator with magnetic sensing functionality could be used as part of a current sense, for instance to sense a magnetic field generated by a current flowing in a conductive path.

The output of an oscillator with magnetic sensing functionality could be decoded using a stable reference clock such as described above, or using another oscillator such as described with reference to FIG. 3. In which case, either separate hall sensors could be used configured so that one oscillator receives more current and the other less current for the same magnetic field, or the same Hall sensor may be shared by sensing delay elements of the two oscillators 200a and 200b. In the example discussed with reference to FIG. 5, the output node of the sensing delay element 201 is connected to electrode 502b of the Hall sensor so the rise time of the sensing delay element 201 varies with the current steered to this electrode 502b. In this example the current steered to electrode 502d is not used. However, it will be understood that any increase in current steered to electrode 502b will result in a consequent reduction in current steered to electrode 502d and vice versa. Thus, any change in the current through electrode 502b will be matched by an opposite change in the current steered to electrode 502d. Rather than simply waste the current which is steered to electrode 502d, this electrode could be connected to the output node of a sensing delay element of the second oscillator to provide an equal and opposite change in oscillation frequency. This arrangement avoids power wastage can provide greater sensitivity. FIG. 6 illustrates an example of a sensor component where a first oscillator arrangement 601a comprises a plurality of transistors 203 each coupled to a first output electrode of a respective Hall sensor 501 and a second oscillator arrangement 601b comprises a plurality of transistors 203 each coupled to a respective second output electrode of the Hall sensor 501s. The Hall sensors 501 are configured such that a given change in field strength will lead to generally the same variation in current steering between the first and second output electrodes. The frequency the first and second oscillator arrangements will thus both vary with magnetic field strength in a substantially opposite fashion to one another. The output of the first and second oscillator arrangements 601a and 601b may be decoded in a similar manner as illustrated in FIG. 3.

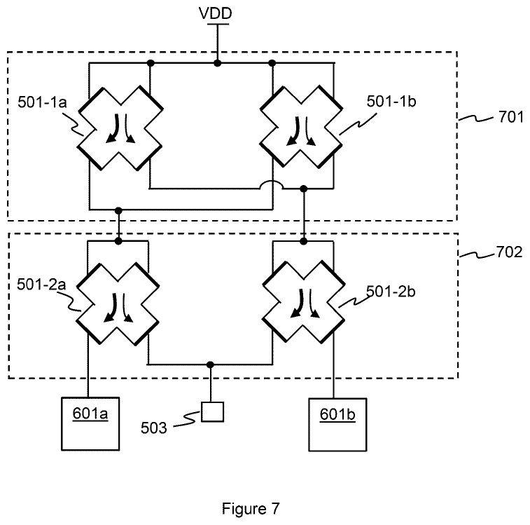

In some embodiments, multiple Hall sensors could be arranged together in a stacked configuration to provide a greater change in current for a given change in magnetic field strength. FIG. 7 illustrates one example of two-layer stack of Hall sensors 501. Each of the Hall sensors has two input electrode and first and second output electrodes and is arranged to steer current received at the input electrodes between first and second output electrodes. The Halls sensors are configured so that a given magnetic field will lead to similar steering of current between the first and second output electrodes for each of the Hall sensors. A first tier 701 of Hall sensors comprises one or more Hall sensors and, in this example, comprises two Hall sensors 501-1a and 501-1b. The second tier 702 of Hall sensors comprises two Hall sensors 501-2a and 501-2b. The first output electrode of each of the Hall sensors of the first tier is configured to provide current to the input electrodes of one of the Hall sensor of the second tier, in this example Hall sensor 501-2a, and the second output electrode of each of the Hall sensors of the first tier is configured to provide current to the input electrodes of the other Hall sensor of the second tier, in this example 501-2a. The first electrode of the Hall sensor 501-2a provides current to the oscillator arrangement 601a and the second electrode of the Hall sensor 501-2b provides current to the other oscillator arrangement 601b.

In use, in the first tier, the Hall sensors operate to steer current between the first and second output electrodes such that a fraction Pa of the current through the Hall sensor is steered to the first output electrode and a fraction Pb(Pb=1-Pa) is steered to the second output electrode. Assuming the input current lin for each of the Hall sensors 501-1a and 501-1b is the same, the current supplied to the Hall sensor 501-2a of the second tier is thus equal to 2lin*Pa and the current supplied to the Hall sensor 501-2a of the second tier is thus equal to 2lin*Pa.

The Hall sensors of the second tier steer current in the same fashion and thus Pa of the input current supplied to the Hall sensor 501-2a is steered to its first output electrode. The current supplied to the first oscillator arrangement 601a is thus Pa(lin*Pa)=lin*Pa². Similarly the current steered to the second electrode of the Hall sensor 501-2b of the second tier, and hence to the second oscillator arrangement 601b is thus Pb(lin*Pb)=lin*Pb2. In this example the current at the second output electrode of the Hall sensor 501-2a and the first output electrode of Hall sensor 501-2b is ignored and these electrodes may be connected to a suitable termination 503.

It can thus be seen that stacking of the Hall sensors in this way effectively amplifies the current steering due to applied magnetic field.

It should be noted that Hall sensors are just one example of a sensor component that can provide a variable current for a sensing delay element of an oscillator with sensing functionality and other type of sensor component where an output current varies with a measurand of interest could be implemented.

Embodiments of the present disclosure thus provide for oscillators with a sensor functionality, i.e. where an oscillation frequency/period of the oscillator varies with a measurement of interest. Embodiments may be implemented without requiring p-channel devices and are suitable for use in material system such as GaN, although the principles could be applied making use of p-channel devices. The examples have been described with a switching device such as an n-channel or HEMT transistor as a controlled pull-down element and the sensing functionality implemented as part of a pull-up arrangement but it will be understood that a delay element could be implemented in some material systems with a controlled pull-up arrangement and a sensor component, such as a variable resistance or current steering element, as part of a pull-down arrangement. It will also be understood that the oscillators may comprise other components, for instance series resistances may be implemented between the delay elements in some applications. The examples have been described in respect of single-ended oscillators but differential oscillators could be used in some embodiments, at the expense of an increased number of components.

Embodiments may be implemented in a host device, especially a portable and/or battery powered host device such as a mobile computing device for example a laptop, notebook or tablet computer, or a mobile communication device such as a mobile telephone, for example a smartphone. The device could be a wearable device such as a smartwatch. The host device could be a games console, a remote-control device, a home automation controller or a domestic appliance, a toy, a machine such as a robot, an audio player, a video player. It will be understood that embodiments may be implemented as part of a system provided in a home appliance or in a vehicle or interactive display. There is further provided a host device incorporating the above-described embodiments.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope

As used herein, when two or more elements are referred to as “coupled” to one another, such term indicates that such two or more elements are in electrical, mechanical, or electromechanical communication, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. A sensor apparatus comprising:
a first ring oscillator comprising a plurality of delay elements configured to generate a first oscillator signal;
wherein at least one of the delay elements comprises a sensing delay element which comprises a sensor component with an electrical property that varies with a measurand of interest to vary a propagation delay of the sensing delay element and hence an oscillation frequency of the first oscillator signal.

2. The sensor apparatus of claim 1 wherein the sensing delay element comprises the sensor component connected in series with a switching device, wherein a control terminal of the switching device is configured to be driven by an input to the sensing delay element and an output of the sensing delay element is taken from a node between the series connected sensor component and switching device.

3. The sensor apparatus of claim 2 where the switching device comprises is an n-channel transistor or an enhancement high electron mobility transistor.

4. The sensor apparatus of claim 1 wherein each of the plurality of delay elements of the first ring oscillator comprises a sensing delay element.

5. The sensor apparatus of claim 1 wherein the sensor component comprises a resistance having a resistance value which varies with the measurand of interest.

6. The sensor apparatus of claim 5 wherein the measurand of interest is temperature and the resistance has a first temperature coefficient of resistance.

7. The sensor apparatus of claim 5 wherein the measurand of interest is strain and the variable resistance comprises a resistive strain sensor.

8. The sensor apparatus of claim 5 wherein the resistance comprises a two-dimensional electron gas resistive element.

9. The sensor apparatus of claim 8 configured for sensing for one or more target chemical analytes of interest, wherein the sensor apparatus comprises a functional layer overlying the two-dimensional electron gas resistive element, wherein the functional layer is configured to interact with the one or more target chemical analytes of interest to vary a charge or electric field distribution over the two-dimensional electron gas and hence the resistance of the two-dimensional electron gas resistive element.

10. The sensor apparatus of claim 1 wherein the sensor component comprises a variable current component that provides a current which varies with the measurand of interest.

11. The sensor apparatus of claim 10 wherein the measurand of interest is a magnetic field strength and the variable current component comprises a Hall sensor configured to provide current steering between first and second output electrodes.

12. The sensor apparatus of claim 11 further comprising a second ring oscillator with at least one sensing delay element wherein the Hall sensor is configured as a shared sensing component for a sensing delay element of each of the first and second ring oscillators, wherein the Hall sensor is connected as part of the sensing delay element of the first ring oscillator via the first output electrode and is connected as part of the sensing delay element of the second ring oscillator via the second output electrode.

13. The sensor apparatus of claim 11 wherein the variable current component comprises a plurality of Hall sensors configured in a stacked arrangement such that an output current from one of the first and second output electrodes of a first one of the Hall sensors provides an input current for a second one of the Hall sensors.

14. The sensor apparatus of claim 1 further comprising a second ring oscillator comprising a plurality of delay elements configured to generate a second oscillator signal, wherein the first and second rings oscillators are configured such that any variation in frequency of the second oscillator signal with the measurand of interest is different to the variation in frequency of the first oscillator signal.

15. The sensor apparatus of claim 14 wherein the second ring oscillator is configured such that the frequency of the second oscillator signal does not vary with the measurand of interest.

16. The sensor apparatus of claim 14 further comprising a counter configured to count a number of oscillations of one of the first and second oscillator signals in a count period, and a frequency divider configured to apply frequency division to the other of the first and second oscillator signals to define the count period.

17. The sensor apparatus of claim 1 implemented as a gallium nitride based integrated circuit.

18. A sensor apparatus comprising:
a first ring oscillator comprising a plurality of delay elements configured to generate a first oscillator signal;
wherein at least one delay element comprises a sensor component connected between a first voltage and a delay element output node and a switching device connected between the delay element output node and a second voltage;
wherein the sensor component provides at least one of a variable resistance and a variable current that varies with a measurand of interest.

19. A sensor apparatus comprising:
a first ring oscillator comprising a plurality of delay elements configured to generate a first oscillator signal, wherein at least one of the delay elements is configured to provide a propagation delay which varies with a measurand of interest so as to vary a frequency of the first oscillator signal; and
decode circuitry configured to receive and decode the first oscillator signal so as to provide a measurement signal indicative of the measurand of interest.

20. The sensor apparatus of claim 19 wherein the sensor apparatus comprises a second ring oscillator comprising a plurality of delay elements configured to generate a second oscillator signal and wherein the second oscillator signal is used to define a count period for counting a number of oscillations of the first oscillator signal.
